(19) United States
(12) Patent Application Publication
(10) Pub. No.: US 2003/0061116 A1
(43) Pub. Date: Mar. 27, 2003

(54) Overseas stay support system

(75) Inventor: Masafumi Tago, Tokyo (JP)

Correspondence Address: SUGHRUE MION, PLLC, 2100 Pennsylvania Avenue, N.W., Washington, DC, 20037-3213, US

(73) Assignee: NIPPON BISO SERVICE, INC.

(21) Appl. No.: 10/246,452

(22) Filed: Sep. 19, 2002

(30) Foreign Application Priority Data
Sep. 21, 2001 (JP) 2001-288841

(51) Int. Cl. G06F 17/60

(52) U.S. Cl. 705/26

(57) ABSTRACT

An overseas stay support system to support an overseas sojourner and an overseas stay schedule person dealing in personal effects smoothly using a network, without needing complicated work.

An overseas stay support system 1 is the system using a network 5 which regards only the personal effects which became unnecessary when an overseas sojourner goes back as the object of dealing and supports this dealing, including:

a goods database 19 constituted in a user's use language which has at least a field of a transfer area and a field of personal-effects data; input reception means 27 to receive an input of a transfer area in a user's use language through a network 5; goods extraction means 21 to extract a personal-effects data from the goods database 19 by using the transfer area inputted with the input reception means 27 as a key; goods extraction means 21 to extract personal-effects data from the goods database 19 by using the transfer area inputted with the input reception means 27 as a key; and output means 25 to display in a user's use language the personal-effects data extracted by the goods extraction means through a network 5.

### TECHINICAL FIELD OF THE INVENTION

The present invention relates to an overseas stay support system which supports that an overseas sojourner and an overseas stay schedule person deal in personal effects smoothly using a network.

### DESCRIPTION OF THE RELATED ARTS

In recent years, most overseas sojourners repeat entry into and departure from the country per several years. Thereby, the complicated work accompanying move of an overseas sojourner has occurred frequently. For example, a lot of goods which accumulated and were full during overseas stay such as a car, furniture, cookware, and books will become unnecessary because they cannot be brought back to Japan, if a difference and transportation cost of living environment with Japan are taken into consideration. The overseas sojourner who goes back to Japan is having forced a great labor about processing of these disused articles. Further, formalities of arrangements of a move, a tax, insurance, a bank, etc. are also one of the complicated work.

Conventionally, when an overseas sojourner processes a disused article at the time of a homecoming, he/she is processing by performing sale or transfer to the overseas sojourner's friends and acquaintances. Also, referring to large-sized disused articles, such as a car and furniture, special contractors of a spot are requested to sell them, whereas, referring to a disused article of accessories, the overseas sojourner may sell off by the garage sale etc. However, when there is seldom a buyer to these goods, the price of them has to be set up in an amount of money quite cheaper than the wished price. Abandonment disposal must be carried out when it still cannot sell off.

Meanwhile, an overseas sojourner who lives overseas in the near future, and an overseas stay schedule person who is in his/her own country and is planning stay abroad need life necessaries, such as furniture for living overseas. However, when a large-sized life necessary is conveyed from his/her own country, the transportation cost is considerably high. In addition, in the case of an electric product, an electric system differs from his/her own country. Further, in the case of vehicles, the reconstruction for satisfying a complicated procedure and a local standard etc. is required for carrying in. Thus, there are lots of inconveniences in the transportation of a life necessary. Hereupon, the overseas sojourner must newly purchase at a spot. However, acquisition of the information for purchasing a used article is not easy. Therefore, the overseas sojourner and the overseas stay schedule person may use the site about used article dealing in his/her own country or a spot using a network.

However, the conventional site is related with goods dealing in his/her own country mostly. Wherein, there are a variety of exhibitors, and the classification of goods is not performed according to area but is performed according to goods. Also, to the site of a spot, these problems do not exist, but the language of a spot is used.

However, when a disused article is sold off by a conventional method, it is laborious and time-consuming by the time an overseas sojourner finishes sale. In addition, the problem on the language by the difference between the language of his/her own country and the language currently used at the spot arises at the time of the negotiation for selling off, and the problem such that price negotiation becomes troublesome is also involved therein.

Further, when the site related to dealing in used articles is used using a network, conventionally used site has the problem that it is not easy to narrow down to what has sent from the stay destination. Also, to the site of a spot, since the language of a spot is used, there is a problem on language when used by people in other language areas.

Furthermore, a problem is also raised in case moving out and moving in abroad, such that little information can be obtained required at the time of move about formalities of entry into and departure from the country besides arrangements of a move, a driver's license, vehicles purchase, a tax, insurance, a bank, etc.

### SUMMARY OF THE INVENTION

The object of the present invention is to provide an overseas stay support system, wherein the former problems discussed above can be solved, and to support dealing in the personal effects accompanying move overseas of an overseas sojourner and an overseas stay schedule person is performed smoothly, and information offer accompanying move can also be performed.

In order to achieve the above object, an overseas stay support system regards only personal effects which became unnecessary as the object of dealing when an overseas sojourner goes back. The overseas stay support system using the network which supports this dealing comprises:

a goods database constituted in a user's use language having a field of a transfer area where at least a grantor is going to transfer personal effects and a field of personal-effects data concerning the personal effects which is going to be transferred; input reception means for receiving the input of the transfer area in a user's use language through a network; goods extraction means for extracting personal-effects data from said goods database by using the transfer area inputted with the input reception means as a key; and output means for outputting data to display the personal-effects data extracted by the goods extraction means in a user's use language through a network.

According to the constitution described above, an input of a transfer area is first received by the input reception means in a user's use language through a network before personal-effects data is extracted by the goods extraction means from a goods database by using the transfer area inputted with this input reception means as a key. Furthermore, the personal-effects data extracted by the output means is displayed in a user's use language through a network. Therefore, the personal-effects data can be searched by using the transfer area as a key, and search work becomes efficient.

Overseas stay support system described in the second invention, with employment of above constitution, comprises:

said goods database having a sale term field which shows the sale term of personal effects; goods extraction means having term sorting means for rearranging the personal-effects data in an order from the near sale term of said corresponding sale term.

Personal-effects data thus arranged is extracted from said goods database, and in a series of process in which this extracted personal-effects data is outputted by the output means, the personal effects is rearranged in an order from the near sale term by the term sorting means included in the goods extraction means by using the sale term as a key. Therefore, goods which are pressing for a move schedule is carried first, then in order to permit dealing to be promoted. Furthermore, a goods buyer can do the search work efficiently in consideration of the schedule of move.

Also, the invention described in the third invention, in an overseas stay support system according to the first invention comprises:

a goods database having a category field of personal effects; input reception means for receiving an input of a personal-effects category along with a transfer area; goods extraction means for extracting personal-effects data from the goods database by using both of the transfer area and the persona-effects category as a key which were inputted by the input reception means, and output means for outputting the personal-effects data extracted with the goods extraction means through a network.

In this manner, an input of a personal-effects category is received along with a transfer area by the input reception means. Then, personal-effects data is extracted by the goods extraction means from a goods database by using both of the transfer area and the personal-effects category which were inputted by this input reception means as a key. Furthermore, the personal-effects data extracted with the goods extraction means is outputted by the output means through a network. Hence, personal-effects data can be searched by using both of the transfer area and the personal-effects category as a key, and search work becomes efficient.

Also, the fourth invention according to the present invention, in an overseas stay support system described in the first invention, is constituted, wherein,

reception of an input of the transfer area in the input reception means can be selected alternatively from a transfer area list extracted from the field of the transfer area of said goods database.

With this constitution, an input of a transfer area in the input reception means can be selected alternatively from a transfer area list extracted from the field of the transfer area of said goods database. Hence, the input of the transfer area where personal-effects data does not exist is prevented, and search work becomes efficient.

Also, the fifth invention in an overseas stay support system described in the first invention includes a web server which distributes a web page through a network. In the web page distributed as an input screen of the input reception means, the web page of the information about the formalities generated at the time of move abroad and arrangements of a move is linked.

According to the above constitution, a web page of the information about the time of move abroad is linked and displayed from a web server on the web page distributed as an input screen.

Also, the sixth invention according to the present invention, in an overseas stay support system described in the first invention, comprises:

a web page in which the link place prepared beforehand according to the area to link the web page which shows the information about move overseas according to area through a network when outputting the personal-effects data extracted by said goods extraction means with said output means as a web page through a network, and the link place of the area selected by using a transfer area inputted with the input reception means as a key are linked.

According to this constitution, when performing narrow-downing of a transfer area, if the transfer area is inputted as a search key from the input reception means, a web page as a screen of a search result is distributed from a web server. Then, the web page of the information about the time of move in the transfer area inputted on the web page is linked and displayed. Therefore, the information about the formalities generated at the time of move can be obtained according to the transfer area, and information acquisition becomes efficient more.

Furthermore, the seventh invention regards only the goods which an overseas sojourner uses as the object of dealing, and constitutes an overseas stay support system using the network which supports this dealing, comprising:

a goods database constituted by user's use language having a field of a purchase area wherein said overseas sojourner purchases goods and a field of data about goods wishing purchase; input reception means to receive an input of a purchase area in a user's use language through a network; a goods extraction means to extract goods data wishing purchase from said goods database by using a purchase area inputted with said input reception means as a key, and output means to display said goods data wishing purchase extracted by said goods extraction means in a user's use language through a network.

According to the above constitution, an input of a purchase area is first received by the input reception means in a user's use language through a network, before Goods data is extracted from a goods database by the goods extraction means by using the purchase area inputted with this input reception means as a key. In addition, goods data extracted by the output means is displayed by user's use language through a network. Consequently, information about the goods of purchase hope can be made to register into a goods database using the language adjusted to each user. Hence, the user who wants to sell off a disused article can search the buyer of the disused article efficiently by using the data about the disused article as a key from a goods database.

Also, the eighth invention regards only the goods which an overseas sojourner uses as the object of dealing, and constitutes an overseas stay support system using the network which supports this dealing, comprising:

a goods database constituted by user's use language having a field of a transfer area where goods are transferred, a field of data about goods and the discernment information that shows the sale hope or purchase hope of goods; input reception means to receive an input including a transfer area and sale hope or purchase hope in a user's use language through a network; goods extraction means to extract goods data from said goods database by using the discernment information which shows the transfer area inputted with said input reception means and sale hope, or purchase hope as a key; and output means to display the goods data extracted by said goods extraction means in a user's use language through a network.

According to this constitution, an input of a transfer area is first received by the input reception means in a user's use language through a network before goods data is extracted from a goods database by the goods extraction means by using the discernment information which shows the transfer area inputted with this input reception means and sale hope or purchase hope as a key. Furthermore, the goods data extracted by the output means is displayed by user's use language through a network. Thereby, the information about goods of sale hope and purchase hope can be made to register into the goods database efficiently using the language adjusted to each user. Also, both of the goods of sale hope and purchase hope are registered into a goods database to permit dealing of goods to be promoted.

Furthermore, the ninth invention constitutes an overseas stay support system according to the first invention, wherein

said input reception means receives an input of an registrant of the goods registered into said goods database in a user's use language through a network, and said goods extraction extracts a goods data from said goods database by using said registrant inputted with said input reception means as a key.

In this manner, an overseas stay support system can make goods referred to from a goods database for every registrant of goods. Consequently, it becomes easy to deal in plurality of goods with the same registrant. Hence, procedure about goods dealing can be performed with the same registrant and costs, such as a transportation cost, can be saved.

### BRIEF DESCRIPTION OF THE DRAWINGS

FIG. 1 is a schematic diagram of an overseas stay support system according to the invention.

FIG. 2 is a block diagram of an overseas stay support system according to the invention.

FIG. 3 is a block diagram depicting an overseas stay support system functionally.

FIG. 4 is a diagram wherein, A shows a screen of the top page of an overseas support system, and B shows the screen after information retrieval.

FIG. 5 is a diagram showing a goods database.

FIG. 6 is a table of the overseas living information according to area.

FIG. 7 is a flow chart of one mode of the embodiment of an overseas stay support system as shown in FIG. 1.

FIG. 8 is a diagram showing the extraction of data from a goods database, wherein, A shows the state after extraction of a record and B shows the state after sorting of a record respectively.

FIG. 9 is a diagram of a personal-effects list web page.

FIG. 10 is a diagram of a personal-effects data web page.

FIG. 11 is a flow chart of a distribution processing of a move related information.

FIG. 12 is a diagram of a transfer goods registration web page.

FIG. 13 is a diagram of a screen of the top page of an overseas support system according to the second embodiment of this invention.

FIG. 14 is a diagram of a goods database according to the second embodiment of this invention.

FIG. 15 is a diagram of a screen of the top page of an overseas support system according to the third embodiment of this invention.

### DESCRIPTION OF THE PREFERRED EMBODIMENTS

The embodiments of the present invention will now be described more in detail in conjunction with drawings.

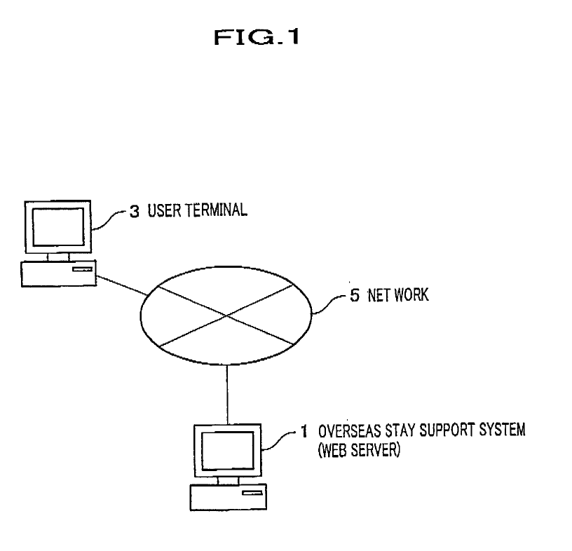

FIG. 1 is a schematic view of an overseas stay support system 1 incorporating the present invention. The overseas stay support system (web server) 1 is connected to a user terminal 3 through a network 5 as shown in FIG. 1. Also, the networks 5 where this system is connected may be networks, such as not only the Internet but a LAN system or a WAN system. If this system which is web server has a demand from the user terminal 3, the demanded web page is distributed through the network 5. Further, the overseas stay support system 1 distributes plurality of web pages which a user searches (henceforth referred as output). The web page is outputted to the user terminal 3 responding to a demand of a user. Further, an input from a user (from the outputted web page) is received.

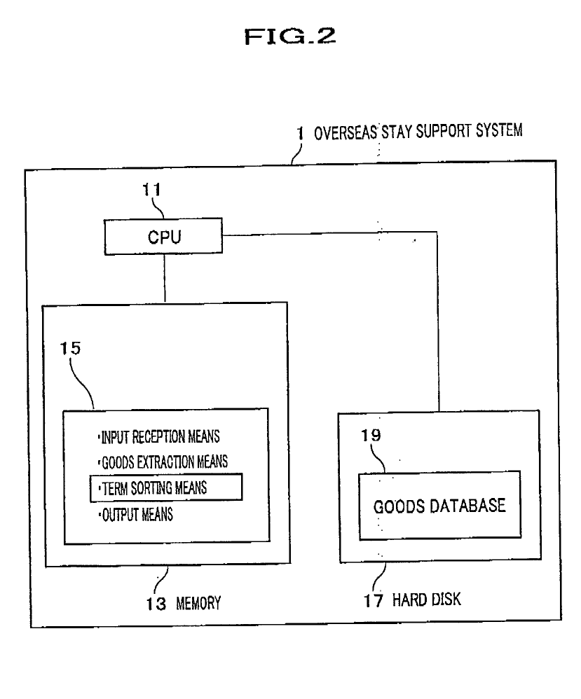

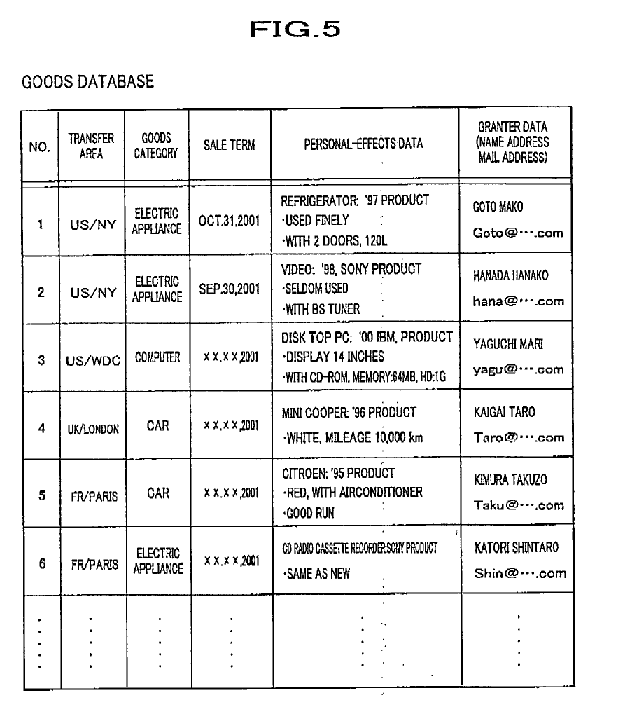

The system constitution of an overseas stay support system 1 will next be discussed based on FIG. 2. The overseas stay support system 1 is constituted by CPU 11, a memory 13, and a hard disk 17 and the like. CPU 11 is a central operation processing part for loading the program and data which are memorized in the hard disk 17 to a memory 13, and performs the loaded program. A program 15 of the overseas stay support system, which is the system of the invention, is loaded to the memory 13. Then, the program 15 searches a goods database 19 memorized in the hard disk 17, and extract the personal-effects data described by a goods database 19 in a memory 13 to refer to. The memory 13 is used also as a work area at the time of CPU 11 performing operation processing. The goods database 19, as hereinafter referred, includes a transfer area field, a goods category field, a sale term field or a personal-effects data field, and a grantor data field, etc., and it is formed in the profile of table. (see FIG. 5).

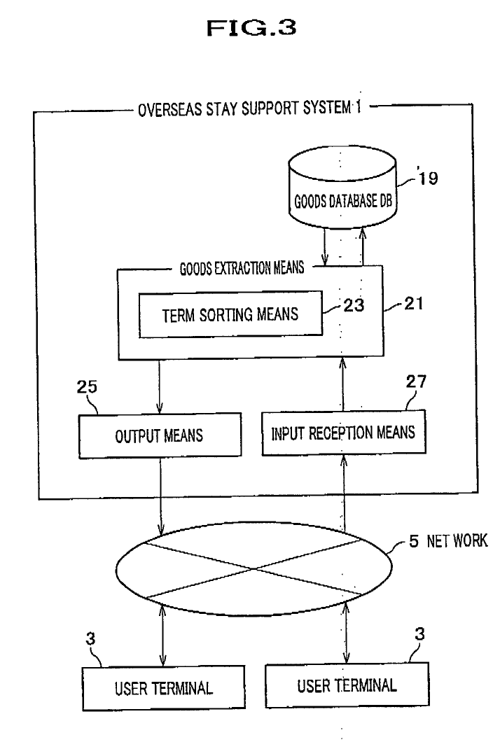

Also, a program 15 corresponds to input reception means, goods extraction means, term sorting means included in the goods extraction means, and data output means through being executed by CPU 11. The constitution of the system seen from the function will now be discussed referring to FIG. 3. The input reception means 27 first receives an input of a transfer area in a user's use language through a network 5 from the web page outputted to a user terminal 3. The goods extraction means 21 next extracts personal-effects data from a goods database 19 by using a transfer area inputted with this input reception means 27 as a key. Furthermore, the output means 25 displays in a user's use language the personal-effects data extracted by the goods extraction means 21 on the web page searched through the network 5 on the user terminal 3 by using the transfer area as a key. Also, the term sorting means 23 included in the goods extraction means 21 rearranges the personal-effects data in an order from the near sale term of the personal-effects using the sale term given in the goods database corresponding to the personal-effects data as a key in the process in which the goods extracting means 21 extracts the personal-effects data from the goods database, and this extracted personal-effects data is outputted by the output moans 25.

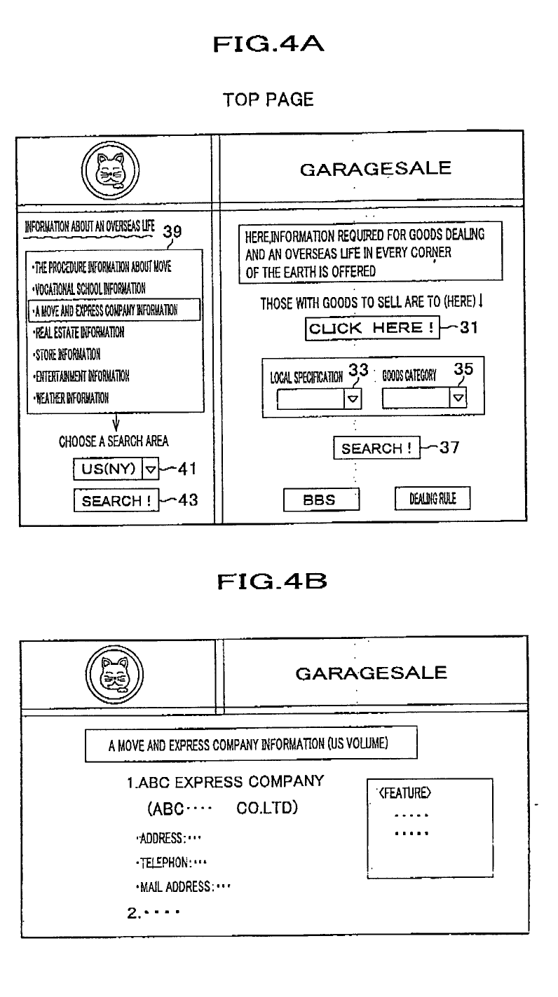

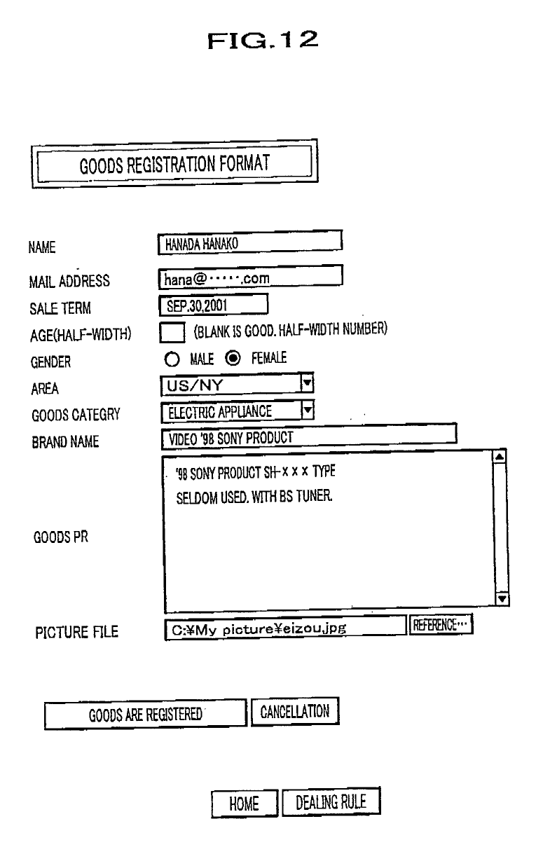

A screen of a top page of this system will next be discussed as shown in FIG. 4A. Incidentally, the top page is intended to be a web page outputted to the beginning of the site which this system outputs. The top page is divided into the frame of right-hand side and left-hand side, and the screen with which the goods dealt in are searched is shown on the right-hand side frame. A local selection box 33 which can choose a designated place region from a pull down menu alternatively, and a goods category selection box 35 which can choose a goods category from a pull down menu alternatively are displayed on this right-hand side frame. And on the bottom of these boxes, a goods search button 37 linked to the overseas stay support system 1 is displayed so that the data chosen with the local selection box 33 and the goods category selection box 35 may be passed to the input reception means 27 and the goods extraction means 21 as an argument. In the right-hand side frame, a transfer goods registration button 31 which outputs a transfer goods registration web page (see FIG. 12) which inputs a personal-effects data to a user terminal 3 is also displayed. The screen on which the information about an overseas life is retrieved is displayed on the left-hand side frame. “The procedure information about move”, “vocational school information”, “a move and express company information”, “real estate information”, “store information”, “entertainment information”, and the “weather information”, etc. are displayed on an information category selection box 39 currently displayed on this frame. From these, one item can be clicked and chosen. And on the bottom of the information category selection box 39, an information area selection box 41 which can choose a designated place region from a pull down menu alternatively is displayed. Furthermore, on the bottom of these boxes, an information retrieval button 43 linked to the overseas stay support system 1 so that the data chosen with the information category selection box 39 and the information area selection box 41 may be passed as an argument is displayed.

A goods database 19 will next be described referring to FIG. 5. A goods database 19 is recorded with data of the following fields:

A transfer area field used as a search key as shown in FIG. 5, in case this goods database 19 performs local search for every record, a goods category field used as a search key in the case of searching every goods category, a sale term field used as a key in the case of arranging personal-effects data in order of a sale term, a grantor data field where the details about grantors, such as the personal-effects data field in which the details about personal effects such as a grantor's name, the address, and a mail address, are described. For example, the first record of the first line is stored in the transfer area field as “US/NY”, in the goods category field as “electric appliance”, in the sale term field as “Oct. 31, 2001”, in the personal-effects data field as “refrigerator '97 product”, and in the grantor field as “Mako Goto and Goto@ . . . com, . . . ”

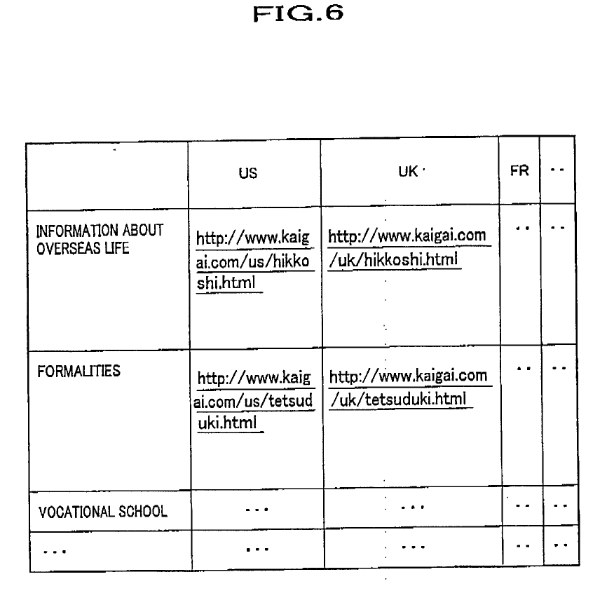

Also, the address of the web page corresponding to an information category selection box 39 in the table of FIG. 6 is stored according to the area. For example, in the area of the first line “US”, following address of the web page is stored as a link place, that is:

as a link place of “a move and express company information.”, “HYPERLINK”http://www.kaigai.com/us/hikkoshi.html http://www.kaigai.com/us/hikkoshi.html:

as a link place of “Formalities”, “HYPERLINK”http://www.kaiqai.com/us/tetsudukihikkoshi.html http://www.kaigai.com/us/tetsuduki.html:

is stored respectively.

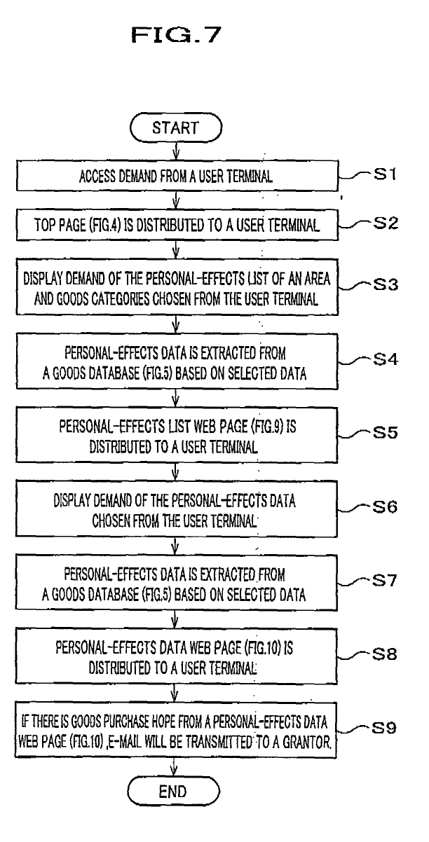

Hereafter, operation of the overseas stay support system 1 will be discussed in conjunction with a flow chart of FIG. 7 in order.

First, when there is an access demand from a user terminal 3 (S1), top page (see FIG. 4A) which is an input screen of this system 1 prepared as data of a web page is distributed to the user terminal 3 (52). Under these circumstances, a pull down menu i.e., which chooses a data of the prepared web page, that is, a local selection box 33, and a goods category selection box 35 is displayed corresponding to a data in a goods database 19. Thereby, the useless search work that a user inputs the area where goods do not exist is not made.

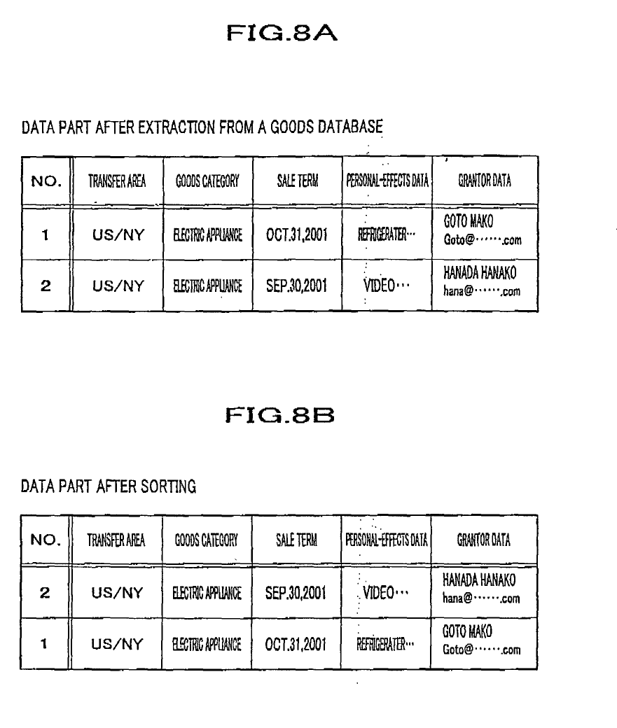

Next, operation from the input in which the transfer area specified by a user and a goods category are inputted from the distributed top page to output in which the list of the personal-effects of the specified area is outputted will be described. In the area specified from the pull-down menu of a local selection box 33 of the right-hand side frame of FIG. 4A (selection of a local search key), the goods category (selection of a goods category key) was alternatively chosen from the pull-down menu, respectively. A goods search button 37 is pressed thereafter. Then, a display demand of the personal-effects list of an area and goods categories chosen from a user terminal 3 is made (S3). First, based on the selected local search key and the goods category key, the goods database 19 (see FIG. 5) is searched, and the personal-effects data of the goods corresponding to these keys is extracted (S4). For example, if “US/NY” is chosen as a local search key and “electric appliance” is chosen as a goods category key, respectively, then, as shown in FIG. 8A, the second record of No. 2 wherein “US/NY” is representative of a field of a transfer area and also “electric appliances” is representative of a field of the goods category in a goods database 19, and the first record of No. 1 are extracted by the goods extraction means 21.

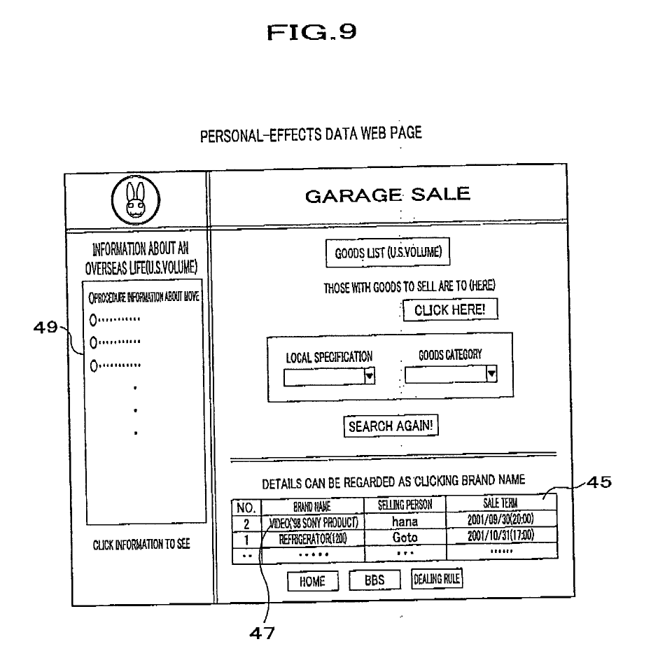

Next, this extracted personal-effects data is sorted by the term sorting means 23 in order from near sale term of the personal-effects data by using the sale term as a key. Namely, as shown in FIG. 8B, by using the sale term as a key, the second record of No. 2 of a sale term “Sep. 30, 2001” is sorted upwards, and the first record of No. 1 of a sale term “Oct. 31, 2001” is sorted downward. The list of this sorted personal-effects data (FIG. 8 (see B) is attached under the right frame in a personal-effects list web page (see FIG. 9), and a personal-effects list web page is outputted to a user terminal 3 (S5). Incidentally, extraction and sorting for personal-effects data from a goods database 19 maybe performed in reversed order. That is, after rearranging the data of the goods database 19 by using the sale term field as a key, the personal-effects data may be extracted by using the transfer field as a key.

This personal-effects list web page (FIG. 9) displays a frame of the overseas living information distributed by linking the link place of the web page of the overseas living information of the area chosen into the left-hand side frame, and outputs to display the frame having same function with the flame for goods search currently displayed on the right-hand side of a top page.

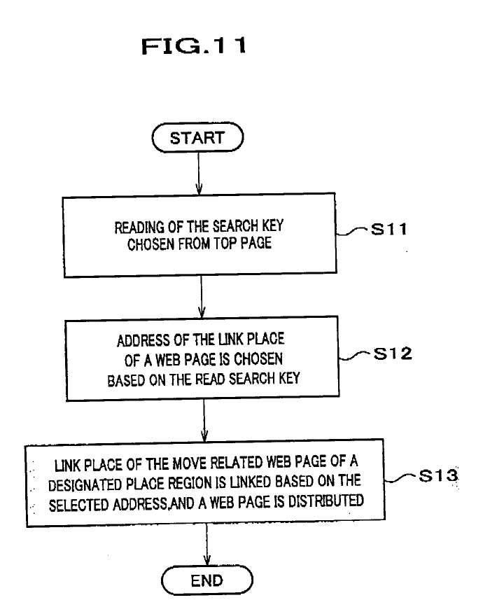

Here, operation which generates the web page of an overseas living information according to area displayed in a left-hand side frame will be discussed according to the flow chart of FIG. 11. A local search key chosen from the top page at Step S3 is read (S11). Next, the address of the web page of the area specified by a user referring to the table of FIG. 6 is chosen by using a local search key as a key (S12). For example, when “US” is chosen from a local selection box 33 of the top page (see FIG. 4A, address is chosen from the table of FIG. 6, as follows:

for the item of “a move and express company information.”, “HYPERLINK”http://www.kaigai.com/us/hikkoshi.html http://www.kaigai.com/us/hikkoshi.html,

for the item of “formalities”, “HYPERLINK—”http://www.kaigai.com/us/tetsuduki.html—http://www.kaigai.com/us/tetsuduki.html.

An address is chosen so that other items may also be linked similarly. Thus, the selected address is set up so that a link maybe stretched in the part of the text in which the information category selection box (US volume) 49 which is in the frame on the left-hand side of a personal-effects list web page (see FIG. 9) is described. Then, this web page is distributed (S 13). In addition, the web page (see FIG. 4B) which shows the information on the selected area is obtained by clicking the part of the text in which the information category selection box 49 according to area (US volume) is given to output to another window. Thus, the web page of the overseas living information according to area is outputted.

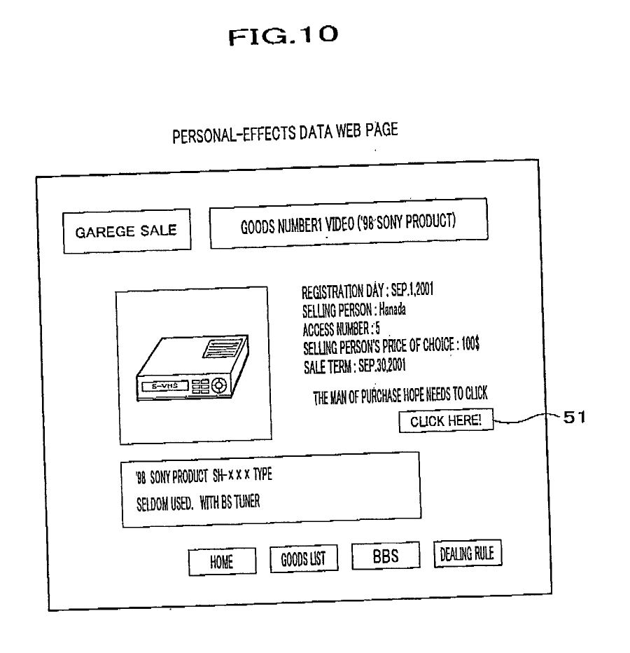

Returning to the flow chart of FIG. 7, operation which distributes a personal-effects data web page (see FIG. 10) in which the contents of personal-effects data demanded by a user from a personal-effects list web page (see FIG. 9) are given will be discussed. In the personal-effects list web page of FIG. 9, the text 47 of the personal-effects data demanded by the user which exists under the right-hand side frame is chosen and clicked (S6). An overseas stay support system 1 uses selected personal-effects data as a key, and the personal-effects data in a goods database 19 (see FIG. 5) is extracted (S7). Further, the contents of this extracted personal-effects data generate the web page displayed on a personal-effects data web page (see FIG. 10), and distribute to a user terminal 3 (S8).

If a purchase hope button 51 in this personal-effects data web page (see FIG. 10) is pressed here, the message from a user (goods buyer) is filled in. The message is sent to a grantor's mail address (S9) thereafter.

In a manner described above, an overseas stay support system 1 of this embodiment can be obtained by easy operation which clicks a data on a web page as information which narrow down the complicated information accompanying move abroad by the area and the goods category. Also, since the list which performs goods search is rearranged by the term sorting means 23 in an order from the near sale term of personal effects to be listed, printing of the goods which are pressing for the move schedule can be performed efficiently. And also, since overseas stay related information is linked to the same screen as the search screen of goods by a top page (FIG. 4A) or a web page of a search result, when it happens to think, information can be accessed immediately. Furthermore, in the web page of a search result, since it is narrowed down to the area which also retrieved related information, required information is obtained more efficiently.

Also, this system can search a web page of the information about move abroad from the top page, and can make a user terminal distribute this web page. The operation will now be described in conjunction with a flow chart of FIG. 11.

In the frame in which an information category selection box 39 on the left-hand side of the top page (see FIG. 4A) is displayed, the text which displayed the item of the related information of search hope is first chosen (selection of an information retrieval key). Then, after selection (selection of a local search key) of the designated place region of search hope is performed from an information area selection box 41, an information retrieval button 43 is pressed.

Here, if “US” is chosen as a local selected search key, and “a move and express company information” is chosen as a selected information retrieval key (S11), for example then, based on the key/a local selected search key and a selected information retrieval key, the address of the web page demanded by a user is chosen (S12) and set up referring to the table of FIG. 6, so as to be linked to the following address: “HYPERLINK”http://www.kaigai.com/us/hikkoshi.html http://www.kaigai.com/us/hikkoshi.html.

A web page of the address shown in FIG. 6 is the web page about various related information described in a user's use language, and is prepared by this system beforehand or detected out of the web page distributed on the network. The web page (see FIG. 4 B) which shows this linked overseas life related information is distributed to a user terminal 3, and made to display on another window (S13). Thus, the link place of the web page in which the information about move overseas in the area wishing search is given is linked, and this linked web page is distributed.

Also, a goods database of this system is created by inputting a data about personal effects from the user who wants to sell goods. Hereafter, the operation will be described with reference to a goods registration format of FIG. 4A and FIG. 12. This goods database 19 will output a transfer goods registration web page (see FIG. 12) which inputs a personal-effects data to a user terminal 3, if a transfer goods registration button 31 currently displayed on FIG. 4A is pressed. The data is stored in each field in the goods database 19 if data is inputted according to each item of this transfer goods registration web page.

As described above, this invention was explained based on the embodiment. However, this invention is not limited thereto.

Hereafter, the second embodiment in the overseas stay support system 1 according to the embodiment of this invention will be explained. The second embodiment is one aspect of the embodiment wherein, the flow of dealing in goods, which corresponds to the personal effects of the first embodiment becomes contrary to the first embodiment. That is, in the first embodiment, an overseas stay support system 1 is considered as a method which shows a purchase candidate a registered goods data in which a goods wishing sell off is made to be registered. Whereas, in the second embodiment, the overseas stay support system 1 is made into a method such as to show a sale candidate the registered goods data of the goods wishing purchase which was made to be registered. Hence, the second embodiment is adapted to be constituted to have the attribute of purchase hope or sale hope for the registered goods added to the first embodiment. Components similar to those previously described with reference to the first embodiment are denoted by the same or similar reference numerals and will not discuss again.

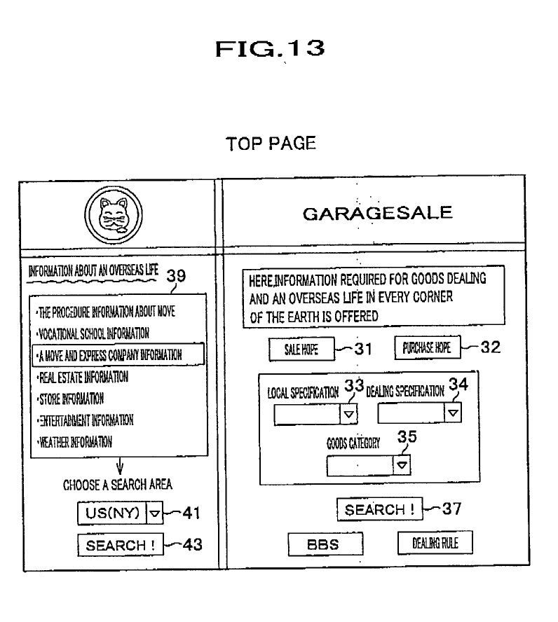

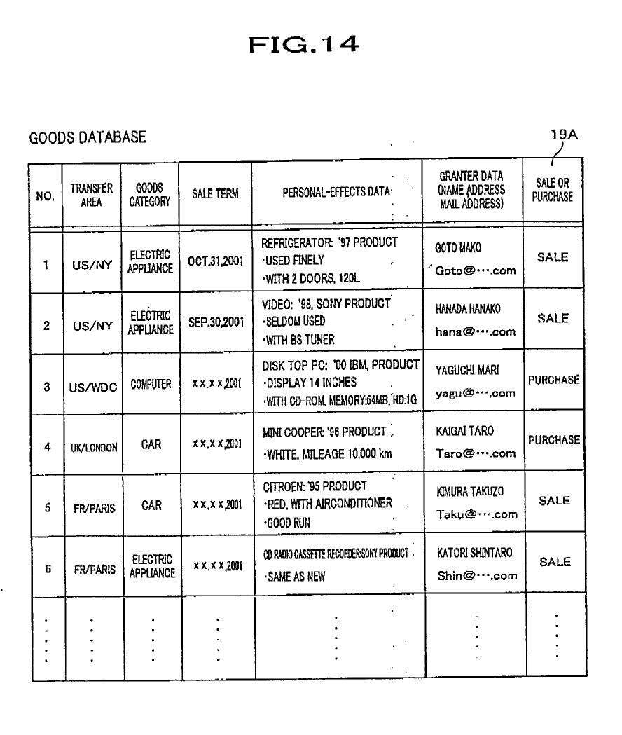

Constitution of the second embodiment will first be discussed referring to FIG. 13 and FIG. 14.

Top page shown in FIG. 13 has the function which enables selection of purchase hope or sale hope added to the top page shown in FIG. 4A in the first embodiment. Also, in addition to the composition element of a top page shown in FIG. 4A, this top page is constituted including a wishing purchase goods registration button 32, and a dealing designation box 34. The wishing purchase goods registration button 32 is used in case a purchase candidate is made to register the wishing purchase goods. The dealing designation box 34 is used in case the goods registered into the overseas stay support system 1 are made to peruse, and the wishing purchase goods or the wishing sale goods (correspond to the personal effects of the first embodiment) is made to choose.

A goods database 19 shown in FIG. 14 has the attribute of purchase hope or sale hope for the registered goods added to the goods database 19 shown in FIG. 5 within the first embodiment. In addition to the composition element of the goods database 19 shown in FIG. 5, this database is constituted including a dealing designation field 19A. The dealing designation field 19A is information from which the goods registered into the goods database 19 is discriminated either purchase hope or sale hope.

Hereunder, operation of the second embodiment will be discussed with reference to FIG. 7.

First, operation at the time of making goods register into an overseas stay support system 1 will be explained. First, the overseas stay support system 1 shows a user the top page shown in FIG. 13, and registration of goods is urged. Next, the overseas stay support system 1 shows the user a goods registration format shown in FIG. 12 ignited by pressing down the button by the user of a transfer goods registration button 31, or a wishing purchase goods registration button 32. And the overseas stay support system 1 registers the information about the goods inputted by the user into the goods database 19 similarly to the first embodiment. As for the overseas stay support system 1, here, when pressing down of the button of the transfer goods registration button 31 is made, “sale” is given in a dealing designation field 19A. Whereas, when pressing down of the button of the purchase hope goods registration button 32 is made, “purchase” is given in the dealing designation field 19A respectively to be registered into it.

Operation at the time of making a user present the goods registered into an overseas stay support system 1 will next be explained with reference to FIG. 7. Referring to operation from distribution (S2) of a top page to extraction (S4) of a personal-effects list, the second embodiment adds the processing which is made referring to the dealing attribute. And the other operation is intended to be similar to the first embodiment.

First, an overseas stay support system 1 distributes the top page shown in FIG. 13 to a user (S2), and perusal of the goods registered into a goods database 19 is urged. The overseas stay support system 1 makes a user choose the goods of purchase hope, or the goods of sale hope as goods made to peruse here using a dealing designation box 34.

Next, an overseas stay support system 1 receives a display demand of the personal-effects list from a user terminal (S3). Here, the display demand of a personal-effects list includes the information which identifies either purchase hope or sale hope.

And an overseas stay support system 1 searches a goods database (FIG. 13), and extracts a personal-effects list from the display demand of a personal-effects list (S5). Here, in addition to extraction processing of the first embodiment, the overseas stay support system 1 compares the information which identifies either the purchase hope or sale hope included in the display demand of a personal-effects list, and a dealing designation field 19A to consider the result as a personal-effects list.

As described above, the second embodiment of this invention was shown. According to the second embodiment, the information about the goods of sale hope and purchase hope can be made to register into a goods database efficiently using the language adjusted to each user. Also, both of the goods of sale hope and purchase hope are registered into a goods database to permit dealing of goods to be promoted.

Hereafter, the third embodiment in an overseas stay support system 1 according to the embodiment of this invention will be explained. The third embodiment, in addition to the first embodiment, is adapted to specify the registrant of goods and enables this registrant to extract a personal-effects list at the time of perusal of the goods registered into the overseas stay support system 1. Hence, the third embodiment has the composition element which specifies the registrant of goods added to the composition of the first embodiment. Here, components or operation similar to the first embodiment are denoted by the same or similar reference numerals and will not discuss again.

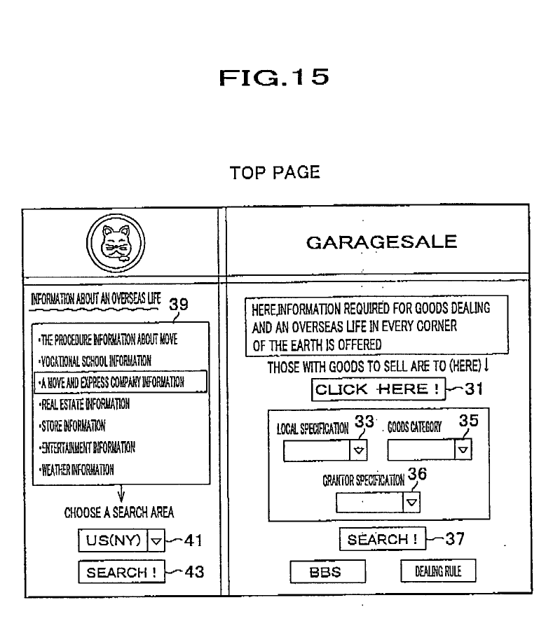

First, composition of the third embodiment will be explained with reference to FIG. 15. The top page shown in FIG. 15 has the function to make it specify a registrant of goods added in the top page shown in FIG. 4A in the first embodiment. In addition to the composition element of a top page shown in FIG. 4A, this top page is constituted including a grantor designation box 36 for designating the registrant of goods.

Operation of the third embodiment will next be explained with reference to FIG. 7. Referring to operation from distribution (S2) of the top page to extraction (S4) of a personal-effects list, the third embodiment has the processing which makes a user specify the registrant of goods added. The other operation is intended to be similar to the first embodiment.

First, an overseas stay support system 1 distributes the top page shown in FIG. 15 to a user (S2), and perusal of the goods registered into a goods database 19 is urged. The overseas stay support system 1 makes a user choose the registrant of the goods registered into the goods database 19 here using a grantor designation box 36. When a user specifies the registrant of goods, it is thought that a user wants to display the personal-effects list of the goods which the selected user registered. In this case, if not specifying a goods category, convenience may improve. Therefore, specification of the goods category selection box 35 may not be indispensable.

Next, an overseas stay support system 1 receives a display demand of a personal-effects list from a user terminal (S3). Here, the display demand of a personal-effects list includes information which identifies the registrant of goods.

And an overseas stay support system 1 searches a goods database (FIG. 13) to extract a personal-effects list from the display demand of a personal-effects list (S5). Here, in addition to extraction processing of the first embodiment, the overseas stay support system 1 compares a registrant and a grantor data field of the goods contained in the display demand of a personal-effects list, and considers the result as a personal-effects list.

As described above, the third embodiment of the invention was shown. According to this third embodiment, it becomes easy to deal in plurality of goods with the same registrant. Thus, procedure about goods dealing can be performed with the same registrant to permit costs, such as a transportation cost, to be saved. Further, an input of the area in the input reception means to deal in is alternatively chosen from a transfer area list extracted from the field of the transfer area of the above goods database. Hence, the input of the transfer area where goods data does not exist is prevented, and search work becomes efficient.

As for the invention explained above, without departing the scope of the invention, various modifications in design are possible.

For example with this embodiment, a designated place region and a goods category are chosen from a pull down menu of the box currently displayed on each screen and an input of a search key is received. However, for the input of a search key, it is also possible to receive the input by inputting a data directly.

Also, this embodiment uses HTML browser as the screen outputting to a user terminal 3, to receive an input. However, it is also possible to use other input reception screens, such as a command input.

Furthermore, with this embodiment, an item currently displayed on an information category selection box 39 of FIG. 4 is described as an example of the related information on the overseas life which can be searched. However, it is also possible to output items, such as an application of a credit card, establishment of a bank account, subscription of insurance, a move application, and a public organization's formalities, as a web page besides these items. In addition, referring to formalities, the procedure of which from a web page is possible, it is also possible to provide information by a document described in the language of the spot, which is required for such formalities, along with the entry point described in a user's use language written together to be arranged so that the necessary procedure may be taken using this information.

Also, correspondence of sale and purchase of goods in the second embodiment and registered goods in the third embodiment made to be displayed per registrant contributes to acquire each effect independently. Therefore, either the second embodiment or the third embodiment may be used, or both of them may be used simultaneously

According to the invention of claim 1, an input of a transfer area is first received by input reception means in a user's use language through a network. Personal-effects data is next extracted from a goods database by goods extraction means by using the transfer area as a key, which was inputted with this input reception means. Further, a personal-effects data extracted by output means is displayed in a user's use language through a network. Thus, in the site according to language adjusted to each user, personal-effects data can be searched by using a transfer area as a key, and search work becomes efficient. Also, people in the same language area can share required information in this site.

According to the second invention, personal-effects data is first extracted from a goods database. By using the sale term as a key, this extracted personal-effects data is rearranged in an order from the near sale term of personal effects by term sorting means included in said goods extraction means to be listed. Thus, printing of the goods which are pressing for the move schedule becomes efficient. Further, search work of the goods buyer who is considering the schedule of a move becomes efficient.

According to the third invention, an input of a personal-effects category is first received with a transfer area by input reception means. Personal-effects data is next extracted from a goods database by goods extraction means by using both of the transfer area and the personal-effects category as a key which were inputted by this input reception means. Further, the personal-effects data extracted with the goods extraction means is outputted by output means through a network. Thus, personal-effects data can be searched by using both of the transfer area and the personal-effects category as a key, and search work becomes efficient.

According to the fourth invention, an input of a transfer area by the input reception means is alternatively chosen from the transfer area list extracted from the field of the transfer area of said goods database. Thus, the input of the transfer area where personal-effects data does not exist is prevented, and search work becomes efficient.

According to the fifth invention, a web page of the information about the time of move abroad is linked and displayed on the web page distributed as an input screen from a web server.

According to the sixth invention, if a transfer area is inputted as a search key from the input reception means, the web page as a secondary screen will be distributed from a web server. Then, on said web page, the web page of the information about the time of move abroad is linked according to an area, and is displayed. Thus, the information about the formalities generated at the time of move can be obtained according to the transfer area, and information acquisition becomes efficient more.

According to the seventh invention, an input of a purchase area is first received by the input reception means in a user's use language through a network. Then, goods data is extracted from a goods database by the goods extraction means by using the purchase area inputted with this input reception means as a key. Further, the goods data extracted by the output means is displayed by a user's use language through a network. Consequently, information about the goods of purchase hope can be made to register into a goods database using the language adjusted to each user. Hence, a user who wants to sell off a disused article can search the buyer of the disused article efficiently by using a data about a disused article as a key from a goods database.

According to the eighth invention, an input of a transfer area is first received by the input reception means in a user's use language through a network. Then, goods data is extracted from a goods database by the goods extraction means by using discernment information which shows a transfer area inputted with this input reception means and sale hope, or purchase hope as a key, and the goods data extracted by the output means is further displayed by a user's use language through a network. Consequently, information about the goods of sale hope and purchase hope can be made to register into a goods database efficiently using the language adjusted to each user. Further, both of the goods of sale hope and purchase hope are registered into a goods database to permit dealing of goods to be promoted.

According to the ninth invention, an overseas stay support system can make goods to be referred to from a goods database for every registrant of goods. Consequently, it becomes easy to deal in plurality of goods with the same registrant. Thus, procedure about goods dealing can be performed with the same registrant to permit costs such as a transportation cost to be saved.

What is claimed is:

1. An overseas stay support system regarding only personal effects, which became unnecessary when an overseas sojourner goes back, as the object of dealing and use the network supporting this dealing, including:
a goods database constituted in a user's use language having a field of a transfer area where at least a grantor is going to transfer personal effects; input reception means receiving the input of the transfer area in a user's use language through a network; goods extraction means to extract personal-effects data from the goods database by using the transfer area inputted with said input reception means as a key; and
output means which output data to display in a user's use language the personal-effects data extracted by said goods extraction means through a network.

2. An overseas stay support system as set forth in claim 1, wherein said goods data base has a field of sale term showing the sale term of a personal-effects, and said goods extraction means includes term sorting means which rearranges personal-effects data in an order from the near sale term of said corresponding sale term.

3. An overseas stay support system as set forth in claim 1, wherein said database has a personal-effects category field, said input reception means receives an input of the personal-effects category, said goods extraction means extracts the personal-effects data from said goods database using both of the transfer area which is inputted by said input reception means and the personal-effects category as a key, and said output means outputs the personal-effects data extracted with said goods extraction means through a network.

4. an overseas stay support system as set forth in claim 1, wherein registration of an input of a transfer area in the input reception means can be alternatively chosen from the transfer area list extracted from the field of the transfer area of said goods database.

5. an overseas stay support system as set forth in claim 1, wherein this overseas stay support system consists of a web server which distributes a web page through a network, in which the web page of the information about the formalities generated at the time of move abroad and arrangements of a move is linked to the web page distributed as an input screen of said input reception means.

6. An overseas stay support system as set forth in claim 1, wherein when a personal-effects data extracted with said goods extraction means is faced outputting as a web page with said output means through a network, the link place of the web page which shows the information about move abroad is prepared beforehand according to an area, and the link place of the area chosen from said link places is linked to said web page using a transfer area inputted with said input reception means as a key.

7. An overseas stay support system which considers only the goods which an overseas sojourner uses as the object of dealing, using a network which supports this dealing, including, a goods database constituted by a user's use language having a field of purchase area where said overseas sojourner purchases a goods and a field of a data about the goods wishing purchase; input reception means to receive an input of a purchase area in a user's use language through a network; goods extraction means to extract said goods data of the goods wishing purchase using the transfer area inputted with said input reception means as a key; and
output means to display said goods data of the goods wishing purchase extracted by said goods extraction means in a user's use language through a network.

8. An overseas stay support system which considers only the goods which an overseas sojourner uses as the object of dealing, using a network which supports this dealing, including,
a goods database constituted in a user's use language having a field of a transfer area for the goods to be transferred, a field of a data about the goods, and a discernment information which shows the sale hope or purchase hope of goods; input reception means which accepts an input including a transfer area, sale hope, or purchase hope through a network; goods extraction means which extracts a goods data from said goods database using the transfer area inputted with said input reception means and a discernment information which shows the sale hope or purchase hope of goods as a key; and
output means which displays the goods data extracted by said goods extraction means in a user's use language through a network.

9. An overseas stay support system as set forth in claim 1, wherein said input reception means accepts an input of the registrant of the goods registered in said goods database in a user's use language though a network, and said goods extraction means extracts a goods data from said goods database using said registrant inputted with said input reception means as a key.
